(19) United States
(12) Patent Application Publication
(10) Pub. No.: US 2023/0132422 A1
(43) Pub. Date: May 4, 2023

(54) METHOD AND SOFTWARE APPLICATION FOR MANAGING PERSONAL FINANCES

(71) Applicant: Alora Baver, Hiddenite, NC (US)

(72) Inventor: Alora Baver, Hiddenite, NC (US)

(21) Appl. No.: 18/051,311

(22) Filed: Oct. 31, 2022

Related U.S. Application Data
(60) Provisional application No. 63/273,197, filed on Oct. 29, 2021.

(51) Int. Cl. G06Q 40/00

(52) U.S. Cl. CPC G06Q 40/00

(57) ABSTRACT

A method or software application for managing personal finances includes collecting information of payees and incomes. A primary income is determined by comparing the income amount of each income and determining which is the highest. Primary income frequencies are set equal to the income frequencies of the primary income. A total amount of bills is calculated from each of the payees for each of the set primary income frequencies, whereby the total amount of bills is equal for each of the primary income frequencies. A total amount of income is calculated for each of the set primary income frequencies. Spending money amount is then determined for each of the set primary income frequencies. A mathematical algorithm is then used to balance the determined spending money over a set period of time by averaging the determined spending money and setting a balanced spending money to the averaged spending money.

### CROSS-REFERENCE To RELATED APPLICATIONS

This application claims benefit to U.S. Provisional Patent Application No. 63/273,197 filed on Oct. 29, 2022, entitled SOFTWARE APPLICATION FOR MANAGING PERSONAL FINANCES, which is incorporated by reference in its entirety.

### FIELD OF THE DISCLOSURE

The present disclosure relates to managing personal finances, and more specifically, for a method and software application for managing personal finances.

### BACKGROUND

Generally speaking, personal finances is the financial management which an individual or a family unit performs to budget, save, and spend monetary resources over time, taking into account various financial risks and future life events. When planning personal finances, the individual or family may consider the suitability to his or her needs of a range of banking products, like checking, savings accounts, credit cards, consumer loans, the like, etc., or may even consider investment in private equity, like companies' shares, bonds, mutual funds, the like, etc. In addition, the individual or family may also consider insurance, products, like life insurance, health insurance, disability insurance, the like, etc. Furthermore, the individual or family may consider participation and monitoring of retirement plans, social security benefits, and income tax management.

Personal circumstances differ considerably, with respect to patterns of income, wealth, and consumption needs. Tax and finance laws also differ from country to country, and market conditions vary geographically and over time. This means that advice appropriate for one person might not be appropriate for another. The key component of personal finance is financial planning, which is a dynamic process that requires regular monitoring and re-evaluation. In general, it involves the steps of assessment, goal setting, plan creation, execution and monitoring and reassessment. There is a great need for people to understand and take control of their personal finances. Typical goals that most adults and young adults have are paying off credit card/student loan/housing/car loan debt, investing for retirement, investing for college costs for children, paying medical expenses. However, currently there are not any adequate resources, tool, or aids for assisting such individuals or families in achieving their financial goals.

Currently, there are many different methods for managing personal finances including various banking products, software application, the like, etc. However, there is always a need to improve these various methods, products and/or software applications, including, but not limited to, designing such various methods, products and/or software applications to use real-time information and algorithms designed to utilize such real-time information for balancing future money and spending. More specifically, none of the known methods, products and/or software applications for personal finances are designed to evaluate the spending amount over the upcoming two-to-six-week period to show an increase or decrease, and then utilizing such an increase or decrease to balance bills and spending money.

The instant disclosure may be designed to address at least certain aspects of the problems or needs discussed above by providing a method and software application for managing personal finances.

### SUMMARY

The present disclosure may solve the aforementioned limitations of the currently available personal finance products, by providing a method and software application for managing personal finances.

The method for managing personal finances may generally include collecting information of at least one payee and collecting information of at least one income. A primary income is then determined by comparing the income amount of each income and determining which of the compared income amounts is the highest. Primary income frequencies are then set equal to the income frequencies of the determined primary income. A total amount of bills is then calculated from the information of each of the payees for each of the set primary income frequencies. Wherein, for any payee with a pay frequency that is larger than the primary income frequencies, the average amount of such payees is split equally into each of the primary income frequencies, whereby the total amount of bills is equal for each of the primary income frequencies. A total amount of income is then calculated for each of the set primary income frequencies from the information of each of the incomes. A spending money amount is then determined for each of the set primary income frequencies, where the spending money is equal to a difference of the calculated total amount of bills for the set primary income frequencies and the calculated total amount of income for the set primary income frequencies. A mathematical algorithm may then be used that may be configured to balance the determined spending money over a set period of time by averaging the determined spending money over said set period of time and setting a balanced spending money to the averaged spending money over said set period of time.

In select embodiments of the disclosed method for managing personal finances, the mathematical algorithm may be configured to balance the spending money over a set period of time. This mathematical algorithm may include, if the total amount of bills for a pay period is less than a following pay period or if the spending money for the pay periods varies, creating an imbalance. With this imbalance created, the determined spending money can then be balanced including subtracting the imbalance from the previous amount of spending money, and then dividing the number of pay periods needed to correct the imbalance. Wherein, the method for managing personal finances may be configured to balance future bills and spending money. In select embodiments, after balancing, the spending money may be equal for the pay period and any following pay period, wherein the balancing may include splitting the imbalance by the number of weeks up to a due date.

One feature of the disclosed method for managing personal finances, the set period of time may be between two to six weeks.

In select embodiments of the disclosed method for managing personal finances, the collecting information of the at least one payee may include: collecting the name of each payee; collecting autodraft info of each payee; collecting an average amount for each payee; collecting a pay frequency for each payee; and collecting a start date for each payee. Wherein, in select embodiments, the information collected for each of the at least one payee may be displayed under a perspective pay period.

In select embodiments of the disclosed method for managing personal finances, the collecting information of the at least one income may include: collecting an income frequency of each income; and collecting an income amount of each income. Wherein, in select embodiments, the income frequency may be selected from a group consisting of: weekly; bi-weekly; monthly; bi-monthly; quarterly; and one time income.

In select embodiments, the method for managing personal finances may further include determining a risk of being overdrawn.

In select embodiments, the method for managing personal finances may further include breaking the payee into cleared amounts, payment left to clear amounts, and past due amounts.

One feature of the disclosed method for managing personal finances may be that the method may include a detailed process, and mathematical equations using the mathematical algorithm, wherein the method for managing personal finances may be configured to work with user inputs, other authorized inputs and artificial intelligence to balance the amounts between a two-to-six-week period by forecasting bills and spending money from paycheck to paycheck.

Another feature of the disclosed method for managing personal finances may be that the method may be configured to use the mathematical algorithm and the artificial intelligence to balance a budget of a user thereby allowing the user to manage money.

Another feature of the disclosed method for managing personal finances may be that the method may be configured to give a detailed evaluation of one pay period bill total then evaluate the amount over the next two-to-six-week period, wherein the method may show an increase or decrease that will be recommended using the mathematical algorithm to balance bills and spending money.

Another feature of the disclosed method for managing personal finances may be that the method may be configured to utilize the mathematical algorithm with real-time information along with user input to calculate current monies spent on bills and spending money.

In another aspect, the instant disclosure embraces the disclosed method for managing personal finances in any of the embodiments and/or combination of embodiments shown and/or described herein.

In another aspect, the instant disclosure embraces a software application for managing personal finances. The software application for managing personal finances may generally include utilizing the disclosed method for managing personal finances in any of the embodiments and/or combination of embodiments shown and/or described herein. As such, the software application for managing personal finances may include collecting information of at least one payee and collecting information of at least one income. A primary income is then determined by comparing the income amount of each income and determining which of the compared income amounts is the highest. Primary income frequencies are then set equal to the income frequencies of the determined primary income. A total amount of bills is then calculated from the information of each of the payees for each of the set primary income frequencies. Wherein, for any payee with a pay frequency that is larger than the primary income frequencies, the average amount of such payees is split equally into each of the primary income frequencies, whereby the total amount of bills is equal for each of the primary income frequencies. A total amount of income is then calculated for each of the set primary income frequencies from the information of each of the incomes. A spending money amount is then determined for each of the set primary income frequencies, where the spending money is equal to a difference of the calculated total amount of bills for the set primary income frequencies and the calculated total amount of income for the set primary income frequencies. A mathematical algorithm may then be used that may be configured to balance the determined spending money over a set period of time by averaging the determined spending money over said set period of time and setting a balanced spending money to the averaged spending money over said set period of time.

In select embodiments of the disclosed software application for managing personal finances, the mathematical algorithm may be configured to balance the spending money over a set period of time. This mathematical algorithm may include, if the total amount of bills for a pay period is less than a following pay period or if the spending money for the pay periods varies, creating an imbalance. With this imbalance created, the determined spending money can then be balanced including subtracting the imbalance from the previous amount of spending money, and then dividing the number of pay periods needed to correct the imbalance. Wherein, the software application for managing personal finances may be configured to balance future bills and spending money. In select embodiments, after balancing, the spending money may be equal for the pay period and any following pay period, wherein the balancing may include splitting the imbalance by the number of weeks up to a due date.

One feature of the disclosed software application for managing personal finances may be that a character or icon may be displayed around any information that was balanced. In select embodiments around this character/icon, the user may be prompted to select the icon/character to begin the balancing process and then must confirm the proposed balanced amounts for the bill(s) selected. As such, in this embodiment, the balancing may not be fully automated, but may require the user to select and confirm to initiate the balancing process of the disclosed method.

One feature of the disclosed software application for managing personal finances, the set period of time may be between two to six weeks.

In select embodiments of the disclosed software application for managing personal finances, the collecting information of the at least one payee may include: collecting the name of each payee; collecting autodraft info of each payee; collecting an average amount for each payee; collecting a pay frequency for each payee; and collecting a start date for each payee. Wherein, in select embodiments, the information collected for each of the at least one payee may be displayed under a perspective pay period.

In select embodiments of the disclosed software application for managing personal finances, the collecting information of the at least one income may include: collecting an income frequency of each income; and collecting an income amount of each income. Wherein, in select embodiments, the income frequency may be selected from a group consisting of: weekly; bi-weekly; monthly; bi-monthly; quarterly; and one time income.

In select embodiments, the software application for managing personal finances may further include determining a risk of being overdrawn and displaying the risk of being overdrawn.

In select embodiments, the software application for managing personal finances may further include breaking the payee into cleared amounts, payment left to clear amounts, and past due amounts and displaying the cleared amounts, payment left to clear amounts, and past due amounts.

One feature of the disclosed software application for managing personal finances may be that the software application may include a detailed process, and mathematical equations using the mathematical algorithm, wherein the software application for managing personal finances may be configured to work with user inputs, other authorized inputs and artificial intelligence to balance the amounts between a two-to-six-week period by forecasting bills and spending money from paycheck to paycheck.

Another feature of the disclosed software application for managing personal finances may be that the software application may be configured to use the mathematical algorithm and the artificial intelligence to balance a budget of a user thereby allowing the user to manage money.

Another feature of the disclosed software application for managing personal finances may be that the software application may be configured to give a detailed evaluation of one pay period bill total then evaluate the amount over the next two-to-six-week period, wherein the software application may show an increase or decrease that will be recommended using the mathematical algorithm to balance bills and spending money.

Another feature of the disclosed software application for managing personal finances may be that the software application may be configured to utilize the mathematical algorithm with real-time information along with user input to calculate current monies spent on bills and spending money.

Another feature of the disclosed software application for managing personal finances may be that the software application may be an internet application.

In another aspect, the instant disclosure embraces the disclosed software application for managing personal finances in any of the embodiments and/or combination of embodiments shown and/or described herein.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

The present disclosure will be better understood by reading the Detailed Description with reference to the accompanying drawings, which are not necessarily drawn to scale, and in which like reference numerals denote similar structure and refer to like elements throughout, and in which:

FIG. 1 is an example of a payee entry chart for the disclosed method and software application for managing personal finances according to select embodiments of the instant disclosure;

FIG. 2 is an example of an income chart for the disclosed method and software application for managing personal finances according to select embodiments of the instant disclosure;

FIG. 3 is an example of various income period options for the disclosed method and software application for managing personal finances according to select embodiments of the instant disclosure;

FIG. 4 is a detailed sheet of an example bi-weekly chart for the disclosed method and software application for managing personal finances according to select embodiments of the instant disclosure prior to balancing by the disclosed method and software application for managing personal finances;

FIG. 5 is a detailed sheet of the example bi-weekly chart of FIG. 4 after balancing by the disclosed method and software application for managing personal finances according to select embodiments of the instant disclosure;

FIG. 6 is an example screenshot for the software application for managing personal finances according to select embodiments of the instant disclosure showing a dashboard with the current income, current pay period, total bills, spending money, and future pay periods;

FIG. 7 is an example screenshot for the software application for managing personal finances according to select embodiments of the instant disclosure showing an example spending money snapshot;

FIG. 8 is an example screenshot for the software application for managing personal finances according to select embodiments of the instant disclosure showing an example next pay period snapshot;

FIG. 9 is an example screenshot for the software application for managing personal finances according to select embodiments of the instant disclosure showing another example next pay period snapshot;

FIG. 10 is an example screenshot for the software application for managing personal finances according to select embodiments of the instant disclosure showing another example next pay period snapshot;

FIG. 11 is an example screenshot for the software application for managing personal finances according to select embodiments of the instant disclosure showing an option to balance the bills using the disclosed method and software application for managing personal finances;

FIG. 12 is an example screenshot for the software application for managing personal finances according to select embodiments of the instant disclosure showing a dashboard with the current income, current pay period, total bills, spending money, and future pay periods after balancing the bills using the disclosed method and software application for managing personal finances;

FIG. 13 is an example screenshot for the software application for managing personal finances according to select embodiments of the instant disclosure showing an example spending money snapshot after balancing the bills using the disclosed method and software application for managing personal finances;

FIG. 14 is an example screenshot for the software application for managing personal finances according to select embodiments of the instant disclosure showing an example left to clear snapshot after balancing the bills using the disclosed method and software application for managing personal finances;

FIG. 15 is an example screenshot for the software application for managing personal finances according to select embodiments of the instant disclosure showing an example pay period snapshot after balancing the bills using the disclosed method and software application for managing personal finances;

FIG. 16 is another detailed sheet of an example bi-weekly chart before balancing by the disclosed method and software application for managing personal finances according to select embodiments of the instant disclosure;

FIG. 17 is a detailed sheet of the example bi-weekly chart of FIG. 16 after balancing by the disclosed method and software application for managing personal finances according to select embodiments of the instant disclosure;

FIG. 18 is another example screenshot for the software application for managing personal finances according to select embodiments of the instant disclosure showing a dashboard with the current income, current pay period, total bills, spending money, and future pay periods;

FIG. 19 is another example screenshot for the software application for managing personal finances according to select embodiments of the instant disclosure showing an example spending money snapshot;

FIG. 20 is another example screenshot for the software application for managing personal finances according to select embodiments of the instant disclosure showing an example next pay period snapshot;

FIG. 21 is another example screenshot for the software application for managing personal finances according to select embodiments of the instant disclosure showing another example next pay period snapshot;

FIG. 22 is another example screenshot for the software application for managing personal finances according to select embodiments of the instant disclosure showing another example next pay period snapshot;

FIG. 23 is another example screenshot for the software application for managing personal finances according to select embodiments of the instant disclosure showing an option to balance the bills of a first rent using the disclosed method and software application for managing personal finances;

FIG. 24 is another example screenshot for the software application for managing personal finances according to select embodiments of the instant disclosure showing an option to balance the bills of a second rent using the disclosed method and software application for managing personal finances;

FIG. 25 is an example screenshot for the software application for managing personal finances according to select embodiments of the instant disclosure showing an example spending money snapshot with left to clear shown after balancing the bills using the disclosed method and software application for managing personal finances;

FIG. 26 is an example screenshot for the software application for managing personal finances according to select embodiments of the instant disclosure showing an example next pay period snapshot after balancing the bills using the disclosed method and software application for managing personal finances;

FIG. 27 is an example screenshot for the software application for managing personal finances according to select embodiments of the instant disclosure showing another example next pay period snapshot after balancing the bills using the disclosed method and software application for managing personal finances;

FIG. 28 is an example screenshot for the software application for managing personal finances according to select embodiments of the instant disclosure showing another example next pay period snapshot after balancing the bills using the disclosed method and software application for managing personal finances;

FIG. 29 is an example screenshot for the software application for managing personal finances according to select embodiments of the instant disclosure showing a dashboard with the current income, current pay period, total bills, spending money, and future pay periods after balancing the bills using the disclosed method and software application for managing personal finances; and

FIG. 30 is a detailed sheet of an example monthly chart before and after balancing by the disclosed method and software application for managing personal finances according to select embodiments of the instant disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

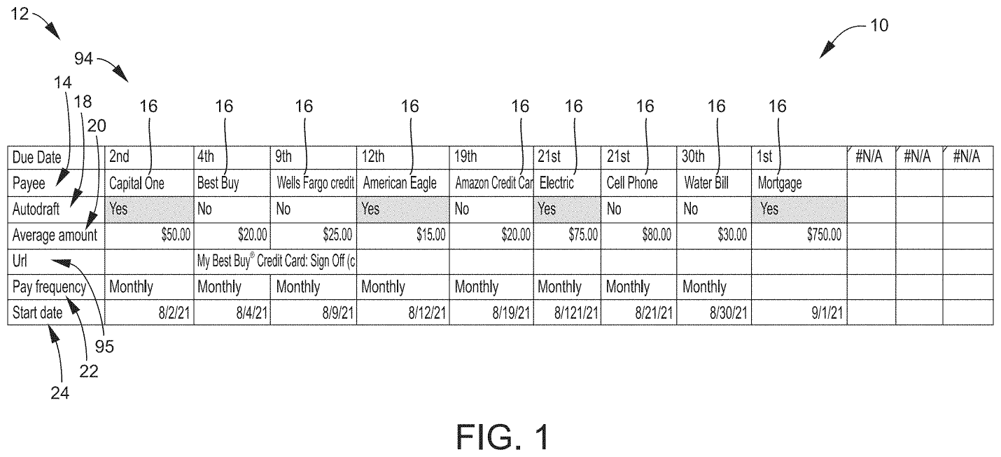

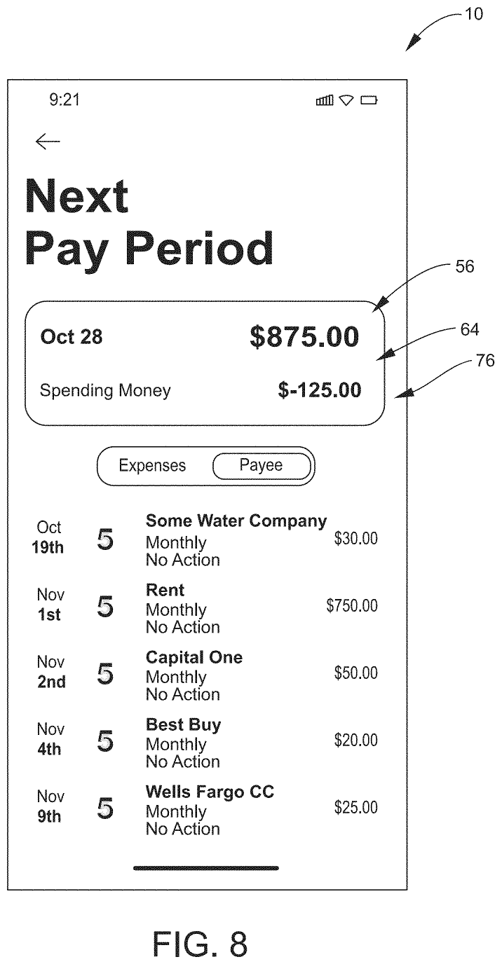

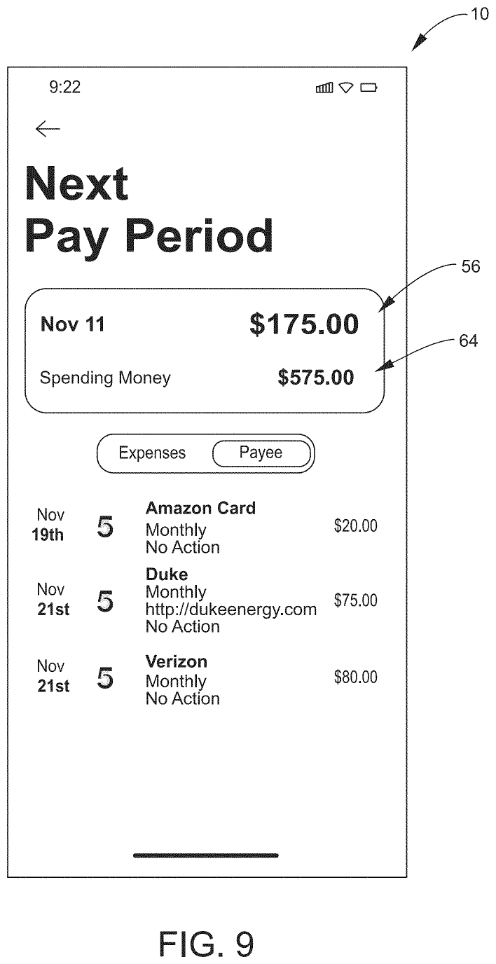

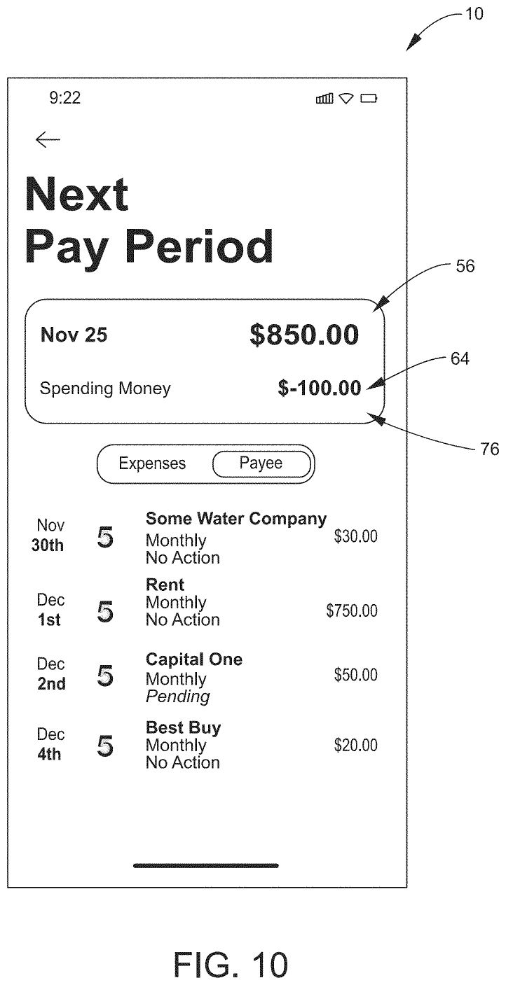

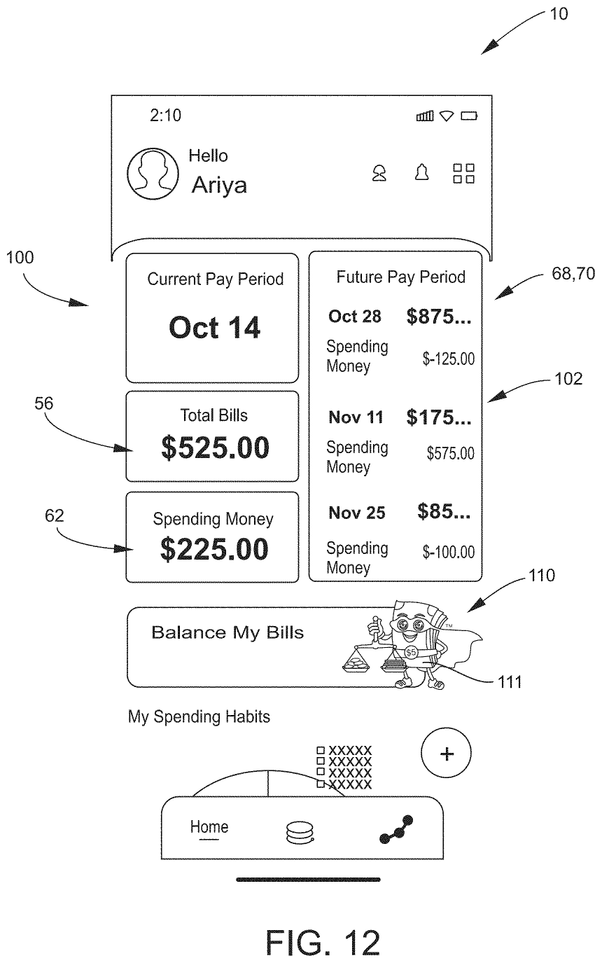

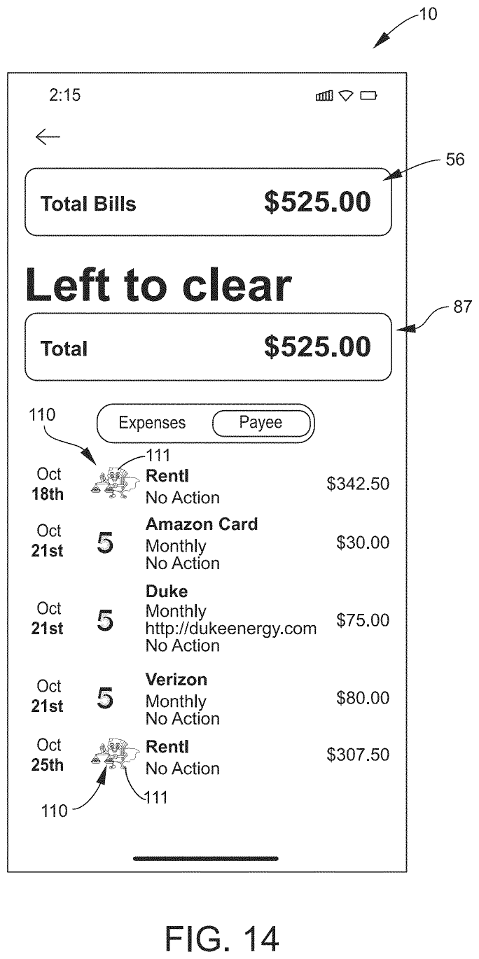

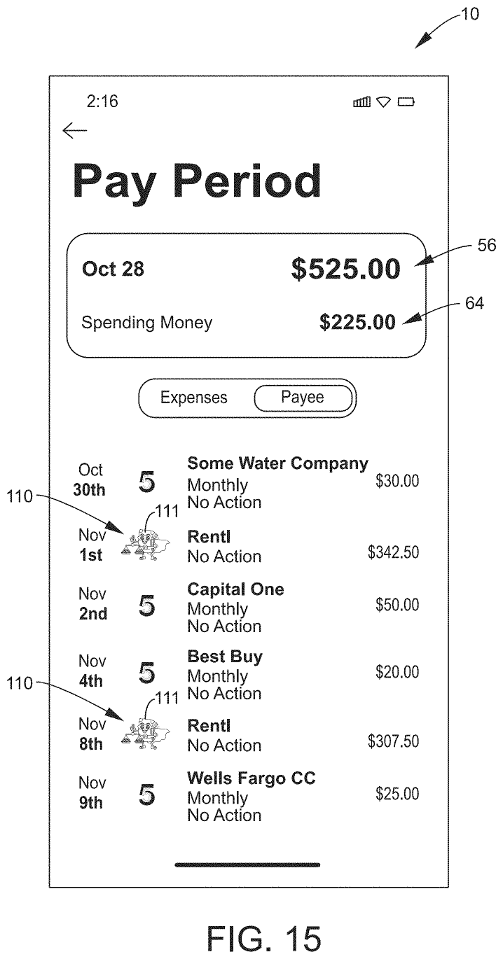

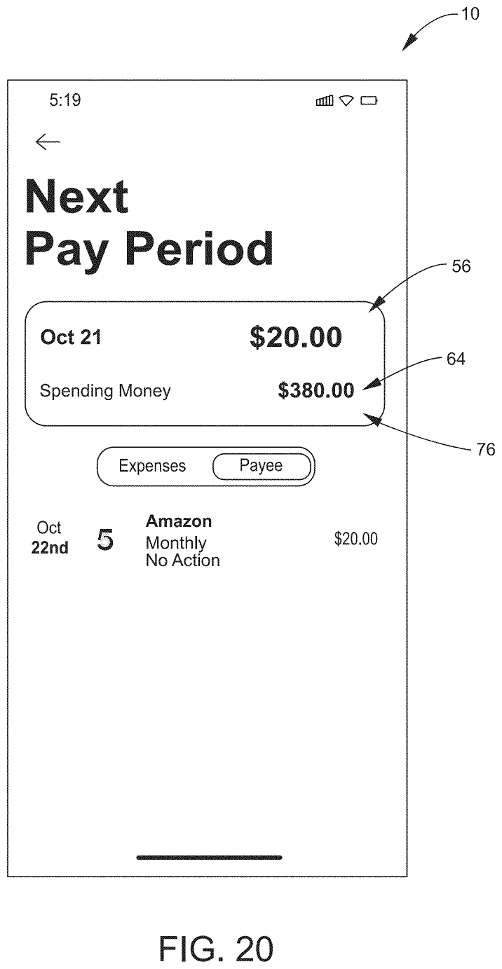

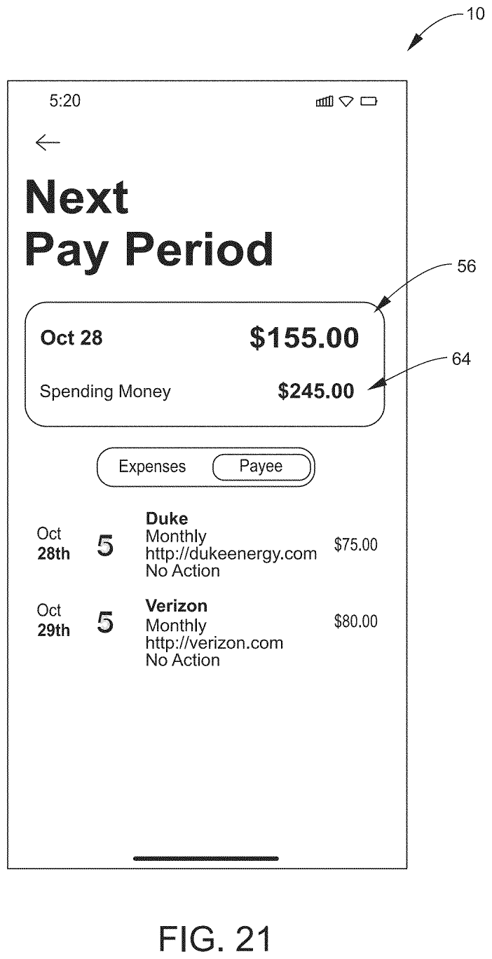

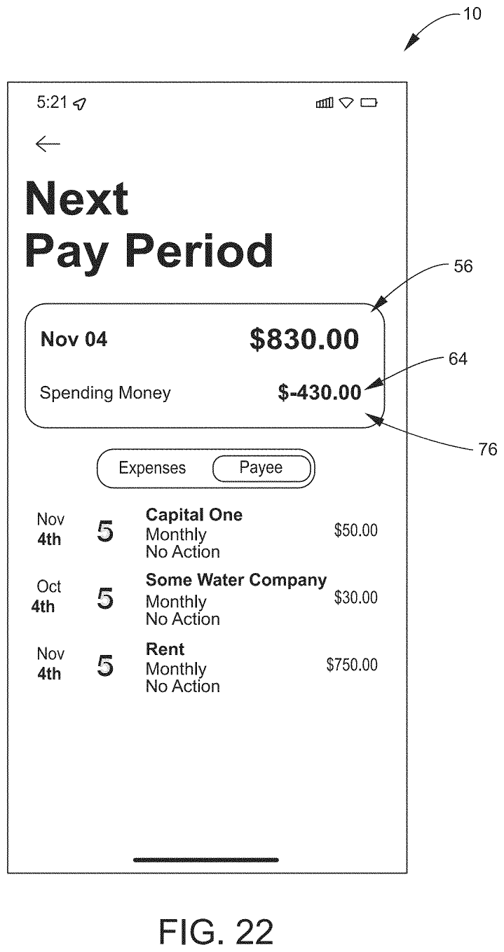

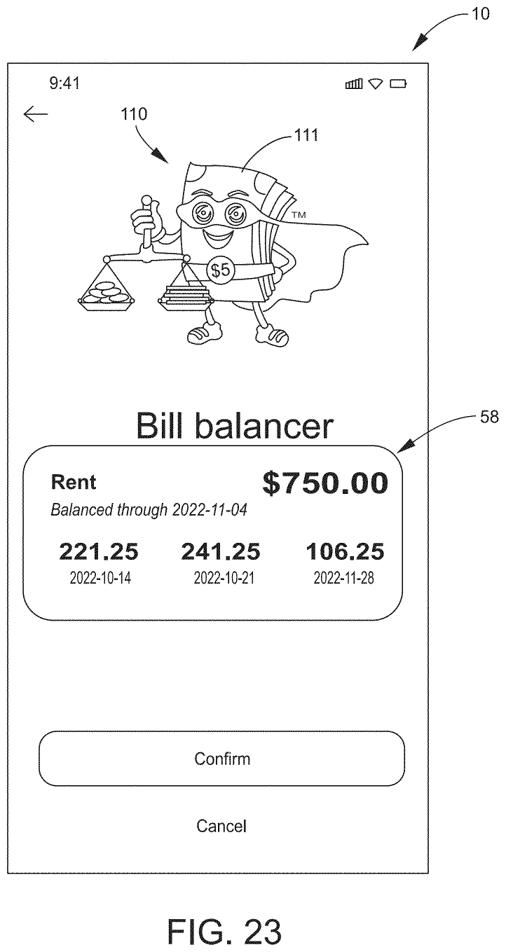

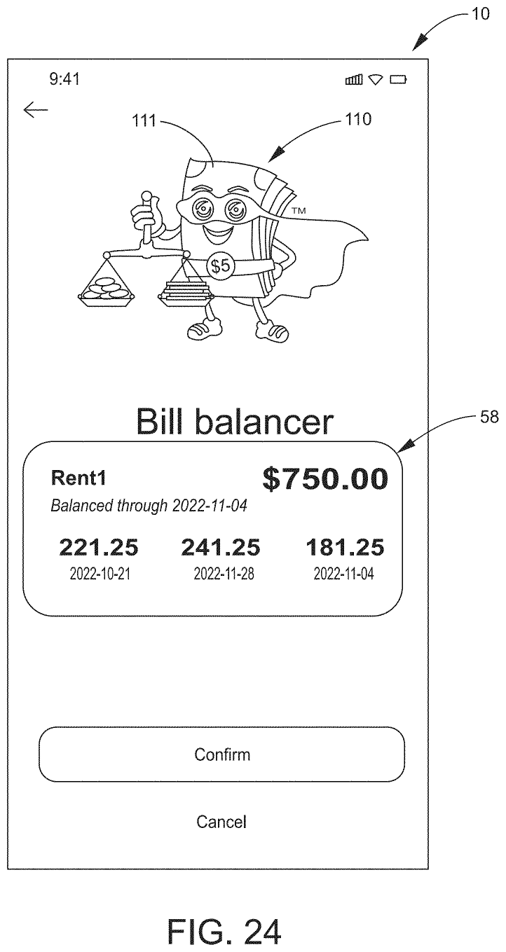

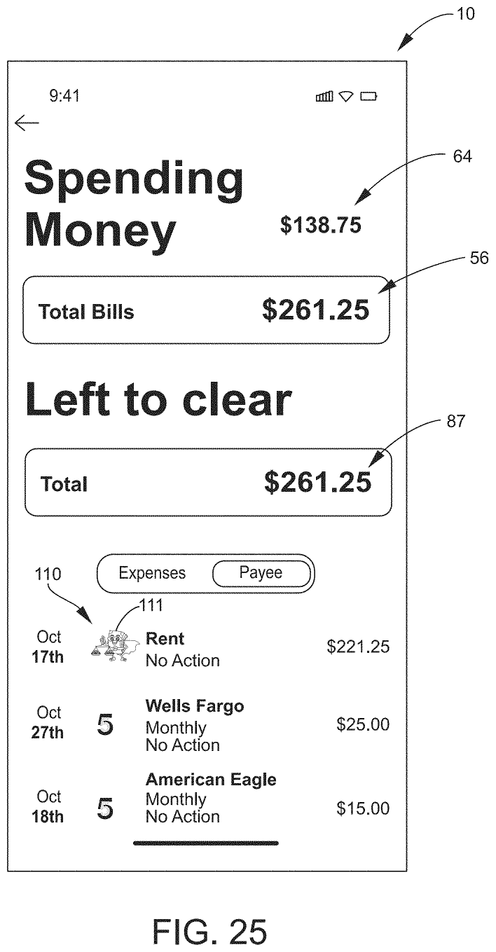

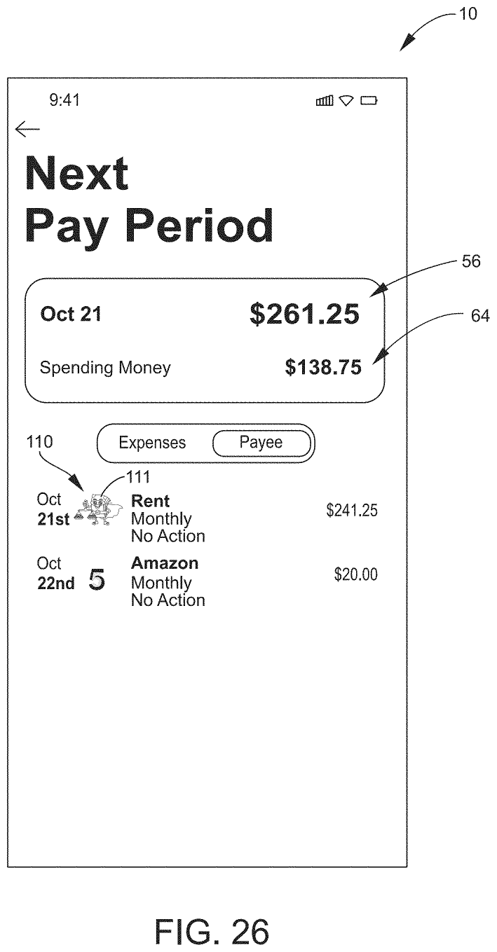

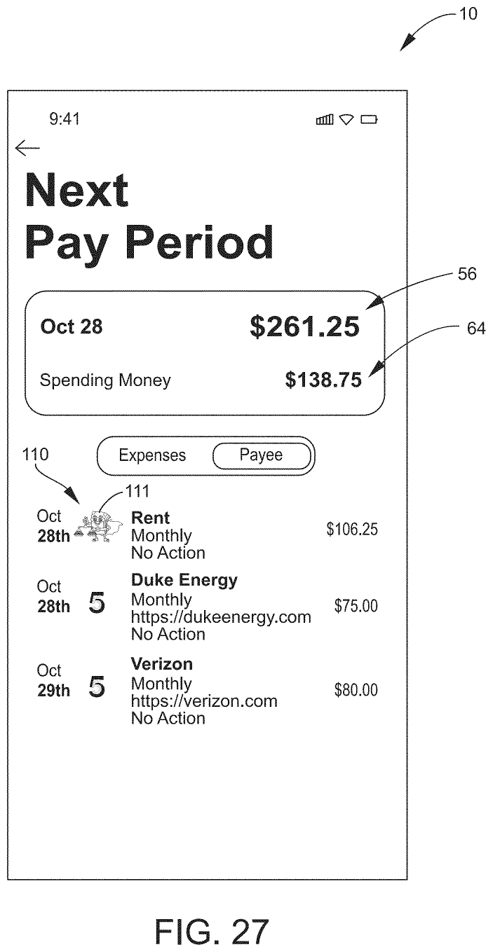

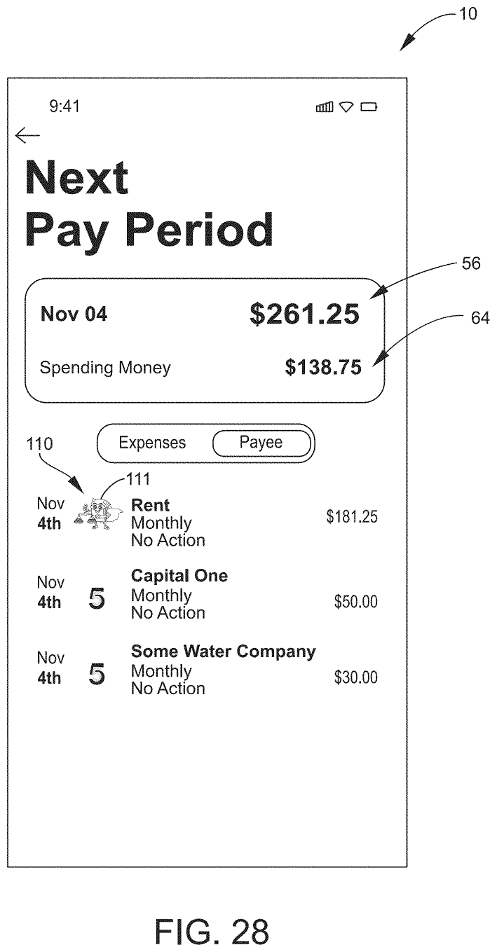

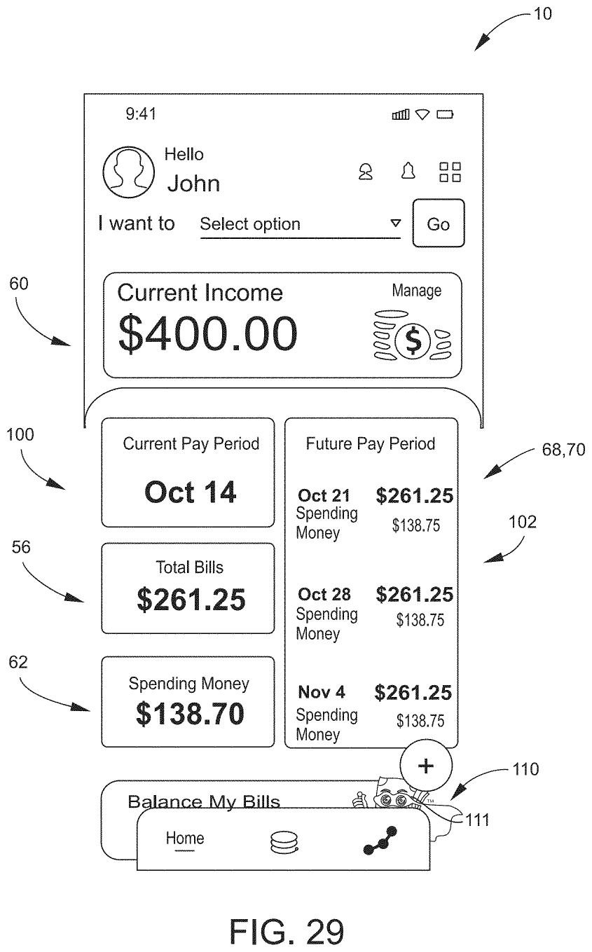

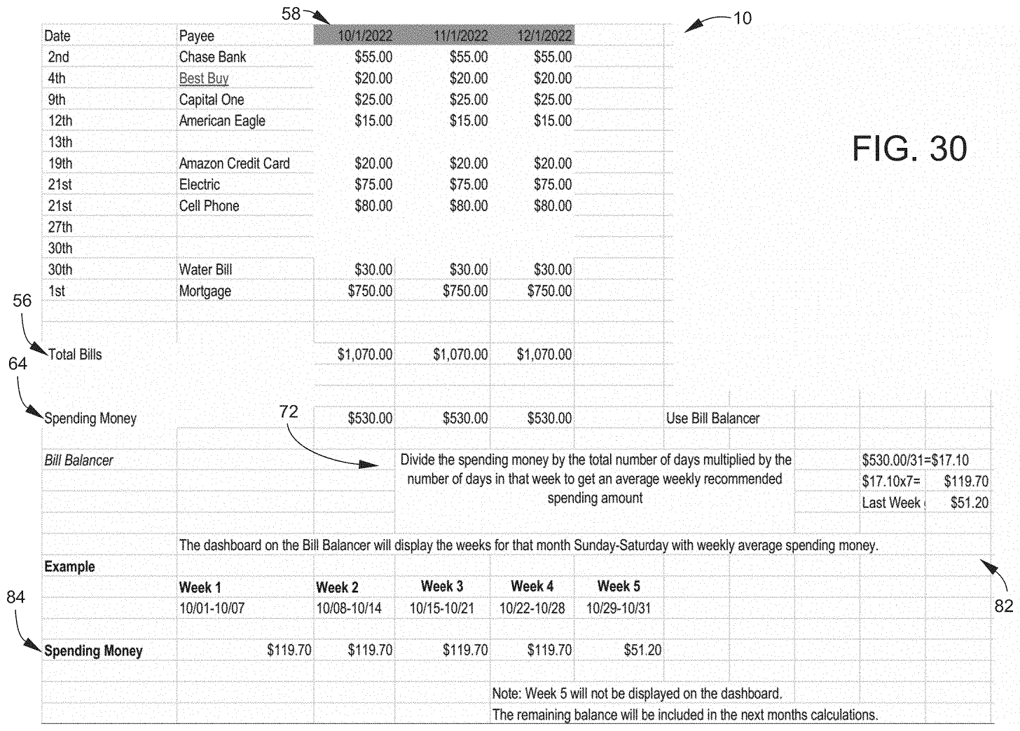

Referring now to FIGS. 1-30, in describing the exemplary embodiments of the present disclosure, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples.

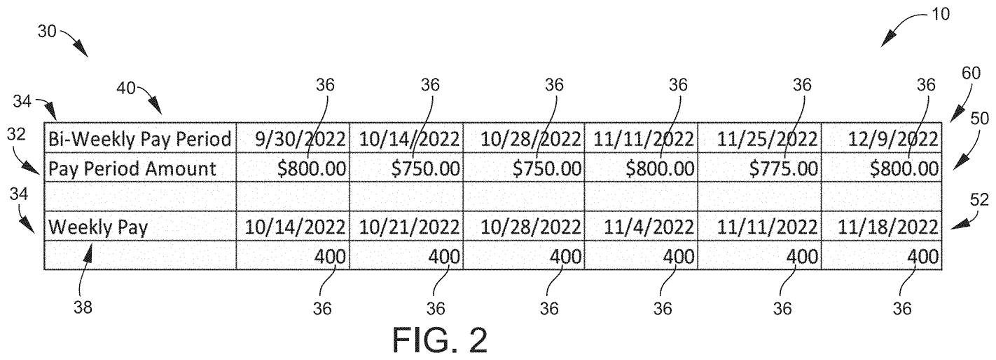

Referring to FIGS. 1-30, the present disclosure may solve the aforementioned limitations of the currently available products and/or services for managing personal finances by providing the disclosed method and/or software application 10 for managing personal finances. Method and/or software application 10 for managing personal finances may generally include step 12 of collecting information of at least one payee 14 (see FIG. 1), and step 30 of collecting information of at least one income 32 (see FIG. 2). These 2 general steps will be described in more detail below.

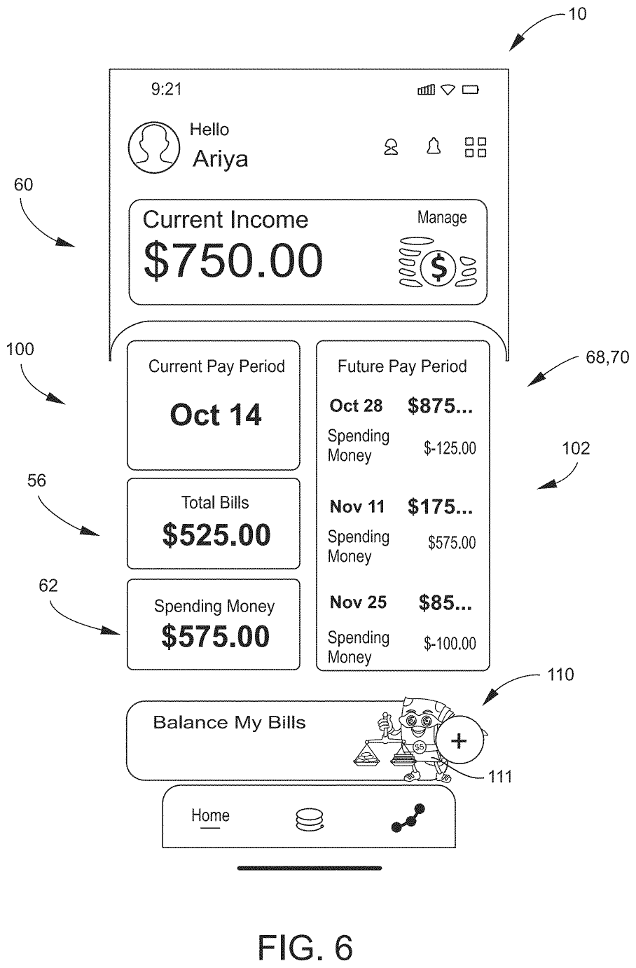

Method and/or software application 10 for managing personal finances may include step 12 of collecting information of at least one payee 14. See FIG. 1. Step 12 of collecting information of at least one payee 14 may include any various steps for collecting any various information from each of the at least one payees 14. This may include the user manually inputting the information of each payee 14 into a spreadsheet, as shown in FIG. 1, or the user providing credentials to login to various URLS to automatically provide authorized inputs 95 for the payee information. Step 12 of collecting information of the at least one payee 14 may include: collecting the name 16 of each payee 14; collecting autodraft info 18 of each payee; collecting an average amount 20 for each payee 14; collecting a pay frequency 22 for each payee 14; and collecting a start date 24 for each payee 14. Wherein, in select embodiments, the information collected for each of the at least one payee 14 may be displayed under a perspective pay period (see FIGS. 6-15 and 18-29).

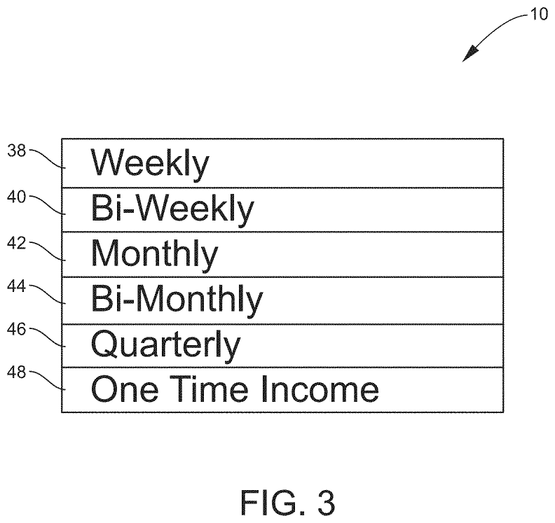

Method and/or software application 10 for managing personal finances may include step 30 of collecting information of at least one income 32. See FIG. 2. Step 30 of collecting information of at least one income 32 may include any various steps for collecting any various information from each of the at least one incomes 32. This may include the user manually inputting 94 the information of each income 32 into a spreadsheet, as shown in FIG. 2, or the user providing credentials to login to various URLS to automatically provide authorized inputs 95 for the income information. In select embodiments of method and/or software application 10 for managing personal finances, the collecting 30 information of the at least one income 32 may include: collecting an income frequency 34 of each income 32; and collecting an income amount 36 of each income 32. The income frequencies collected may be any income frequencies. In select embodiments, as shown in FIG. 3, the income frequency may be selected from a group consisting of: weekly 38; bi-weekly 40; monthly 42; bi-monthly 44; quarterly 46; and one time income 48.

Still referring to FIG. 2, with all of the incomes 32 collected, method and/or software application 10 may then include step 50 of determining a primary income. The primary income may be determined with method and/or software application 10 by comparing 52 the income amounts 36 of each income 32 and determining which of the compared income amounts is the highest. With the primary income determined, primary income frequencies are then set in step 54. The primary income frequencies may be set equal to the income frequencies of the determined primary income.

Referring now to FIGS. 1, 4, 5, 16 and 30, with all of the payees 14 collected, method and/or software application 10 may then include step 56 of calculating a total amount of bills. The total amount of bills may be calculated from the information of each of the payees for each of the set primary income frequencies. One feature of method and/or software application 10 for managing personal finances may be that for any payee with a pay frequency that is larger than the primary income frequencies, the average amount of such payees is split equally into each of the primary income frequencies in step 58. With this process of splitting the payments equally among each of the primary income frequencies, the total amount of bills may be equal for each of the primary income frequencies. In addition, step 60 may include calculating a total amount of income for each of the set primary income frequencies from the information of each of the incomes. Step 62 may then be used to determine spending money amount 64 for each of the set primary income frequencies. The spending money determined in step 62 may be equal to a difference of the calculated total amount of bills for the set primary income frequencies and the calculated total amount of income for the set primary income frequencies. Step 66 may then use a mathematical algorithm configured to balance the determined spending money amount over a set period of time 68 by averaging 72 the determined spending money over said set period of time 68 and setting 74 a balanced spending money to the averaged spending money over said set period of time 68.

Method and/or software 10 for managing personal finances may include utilizing a mathematical algorithm configured to balance the spending money over a set period of time. This mathematical algorithm used in method and/or software 10 may include, if the total amount of bills for a pay period is less than a following pay period or if the spending money for the pay periods varies, creating an imbalance 76. With this imbalance 76 created, the determined spending money can then be balanced 82 including subtracting the imbalance from the previous amount of spending money, and then dividing the number of pay periods needed to correct the imbalance. Wherein, method and/or software application 10 for managing personal finances may be configured to balance 82 future bills and spending money. In select embodiments, after balancing, the spending money may be equal for the pay period and any following pay period, wherein balancing 82 may include splitting 88 the imbalance by the number of weeks up to a due date.

Method and/or software application 10 for managing personal finances may include set period of time 68 for managing or balancing the user's spending money and bills. Set period of time 68 may be any desired period of time for balancing a user's bills and personal finances. In select possibly preferred embodiments, but clearly not limited thereto, the set period of time 68 may be between two to six weeks 70.

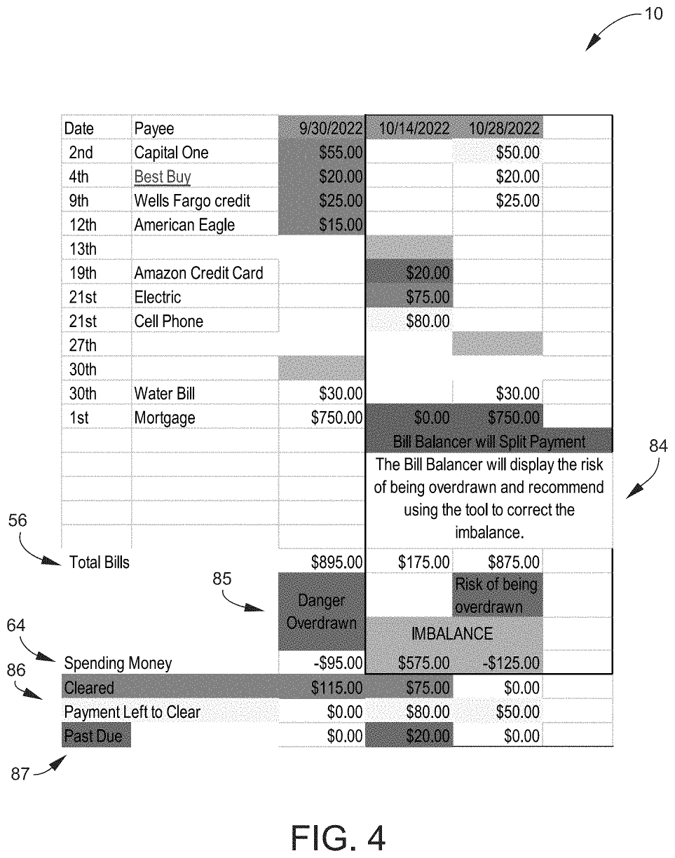

Referring to FIGS. 4, 5, 16, and 17, method and/or software application 10 for managing personal finances may further include determining 84 a risk of being overdrawn. In select embodiments, method and/or software application 10 may include displaying 85 the determined risk of being overdrawn.

Referring now to FIGS. 4, 5, 7, 13, 14, 16, 17, 19, and 25, in select embodiments, method and/or software application 10 for managing personal finances may further include step 86 of breaking the payee 14 into cleared amounts, payment left to clear amounts, and past due amounts. In select embodiments, method and/or software application 10 may include displaying 87 the broken out cleared amounts, payment left to clear amounts, and past due amounts.

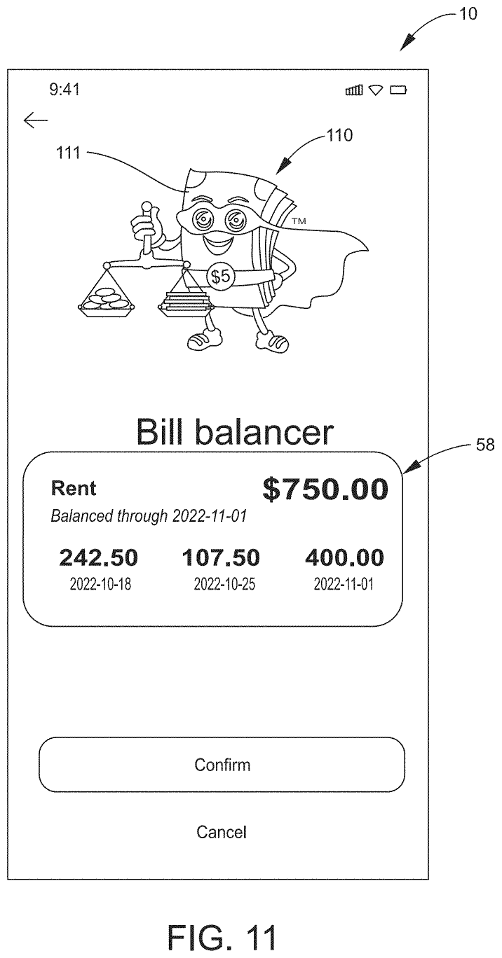

Referring now specifically to FIGS. 6, 11-15, 18, and 23-29, another feature of method and/or software application 10 for managing personal finances may be that character 111, or an icon, may be displayed 110. This display 110 of character 111 may be around any information that was balanced via method and/or software application 10. Character 111 may be a way of playfully and/or intuitively notifying the user of various bills or spending that have been balanced or corrected. As such, character 111 may be a way for the user to learn which places of their personal finances need monitoring. In select embodiments around this character/icon 111, the user may be prompted to select the icon/character 111 to begin the balancing process and then must confirm the proposed balanced amounts for the bill(s) selected (see FIGS. 11, 12, 23, and 24. As such, in this embodiment, the balancing may not be fully automated, but may require the user to select and confirm to initiate the balancing process of method/software application 10 for managing personal finances.

Another feature of method and/or software application 10 for managing personal finances may be that the method and/or software application may be an internet application. This may allow the user to access method and/or software application 10 at any time and at any location.

Referring now to FIGS. 6-14 and 18-29, various screenshots are shown as examples for use with method and/or software application 10 for managing personal finances. It is noted that in these example screenshots it is noted that “no action” is required under each payee 14. In select embodiments, this may be where the various payee bills can be marked or designated at pending, cleared, or past due. In select embodiments, the past due will automatically be applied the day after the due date if the user does not change the status to cleared. Past due bills will affect the left to clear and future spending money amounts. Therefore, the use of character 111, or the “Bill Balancer” of method and/or software application 10, may be needed to balance the spending with the past due bill included.

In another aspect, the instant disclosure embraces the disclosed software application for managing personal finances in any of the embodiments and/or combination of embodiments shown and/or described herein.

In sum, method and/or software application 10 for managing personal finances may include a detailed process, and mathematical equations using the mathematical algorithm, wherein the method for managing personal finances may be configured to work with user inputs, other authorized inputs and artificial intelligence to balance the amounts between a two-to-six-week period by forecasting bills and spending money from paycheck to paycheck.

One feature of the disclosed method and/or software application for managing personal finances may be that method and/or software application 10 may be configured to use the mathematical algorithm and the artificial intelligence to balance a budget of a user thereby allowing the user to manage money.

Another feature of method and/or software application 10 for managing personal finances may be that it can configured to give detailed evaluation 100 of one pay period bill total then evaluate 102 the amount over the next two-to-six-week period, wherein method and/or software application 10 may show an increase or decrease that will be recommended using the mathematical algorithm to balance bills and spending money.

Another feature of method and/or software application 10 for managing personal finances may be that it can be configured to utilize the mathematical algorithm with real-time information along with user input to calculate current monies spent on bills and spending money.

A feature of the present disclosure is its ability to balance future bills and spending money.

Another feature of the present disclosure is its ability to use an algorithm and AI to balance one's budget and the user manage money appropriately.

Another feature of the present disclosure is its ability to give a detailed evaluation of one pay period bill total then evaluate the amount over the next two-to-six-week period. The result will show an increase or decrease that will be recommended using the algorithm to balance bills and spending money.

Another feature of the present disclosure is its ability to provide the algorithm that will use real-time information along with user input to calculate current monies spent on bills and spending money.

### EXAMPLES

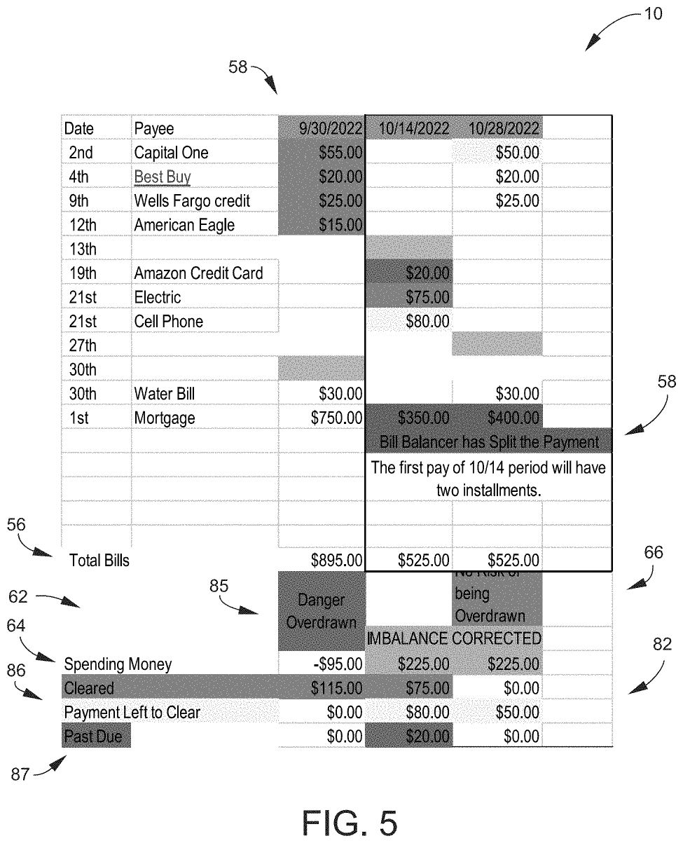

Referring now specifically to FIGS. 4-5, the disclosed method and/or software application 10 for managing personal finances will split Mortgage payment of $750 to balance the spending money and avoid an overdrawn account. This will allow the total amount of bills to be equal from one paycheck to another. As shown, the disclosed method and software application 10 for managing personal finances was not used on the paycheck for Sep. 30, 2022. The account would be overdrawn for this pay period. If total bills for one period is less than following period or the spending money for each pay period varies, the character 111 of method and/or software application 10 can be applied by the user. When applied the character 111 of method and/or software application 10 will subtract the spending money with the imbalance from the previous amount of spending money. The result will then be divided by the number of weeks or pay periods needed to correct the imbalance.

($125)−$575=$450

$450/2=$225; or

$450/4=112.50

This is the amount the spending money should equal for both pay periods. The Bill Balancer will split the amount by the number of weeks up to the due date.

As shown, the $350.00 is the split amount for the mortgage for the pay period of Oct. 14, 2022. The character 111 of method and/or software application 10 will now subtract the withheld amount of $350.00 from the original $750.00 (=$400). This is the new amount to pay for the mortgage payment for the pay period of Oct. 28, 2022.

$575−$225=$350.00

The $350 will be broken into two payments based on the two weeks in the bi-weekly pay period. In the example shown, the first payment is $242.50. The following week $107.50 for a total of $350.00 for the entire pay period. The next pay period due date only allows for one payment of $400.00 to be made.

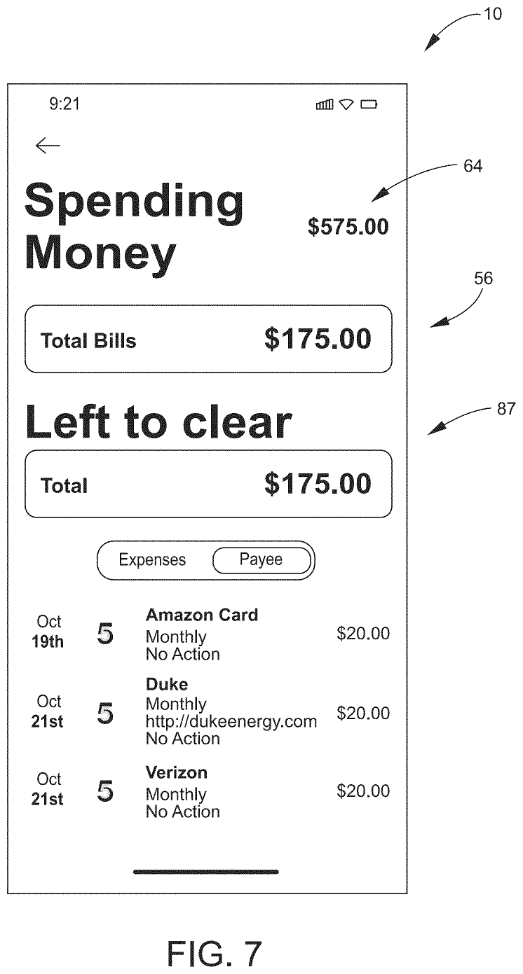

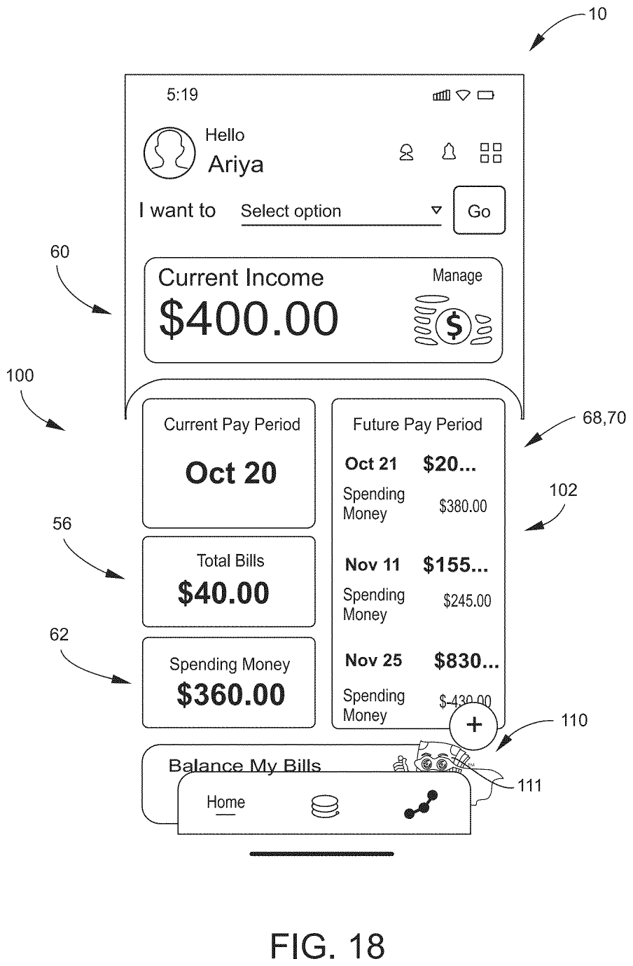

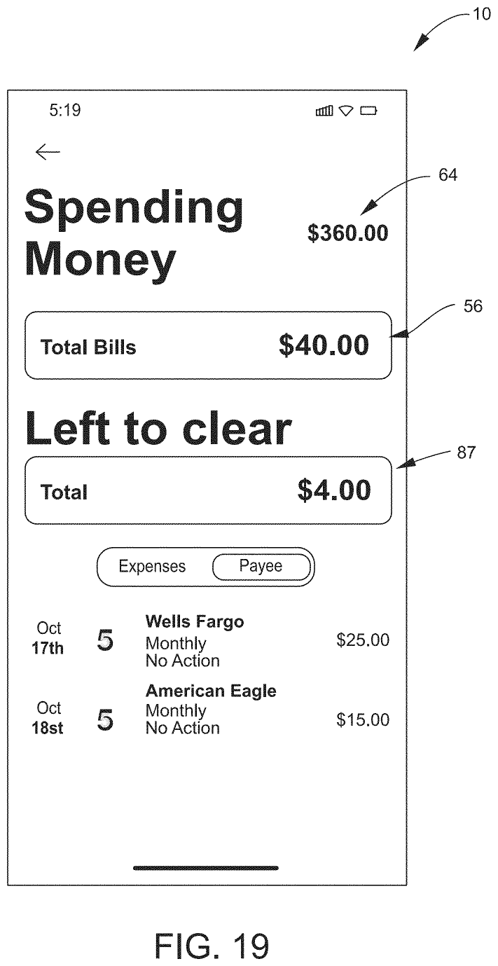

The character 111 of method and/or software application 10, i.e. the “Bill Balancer” as shown (disclosure is not limited to the name “Bill Balancer” and any desired name of character 111 for method and/or software application 10 may be used), may be the external user interface tool used to balance bills and spending money over four to six weeks 70. The first step of the character 111 of method and/or software application 10 may be to identify the larger income recorded. All income is added together, however, the larger income will be used to identify the Pay Period frequency. The application's dashboard will then display the frequency used (See FIGS. 6 and 18). The income entered was for a bi-weekly pay period. The second step of the character 111 of method and/or software application 10 may be to identify all the bills recorded and display them under the perspective pay period. (See FIGS. 6-10 and 19-22). A summary of the total dollar amount of bills is displayed on the dashboard (FIGS. 6 and 19). The last step of the character 111 of method and/or software application 10 may be to subtract all the bills from the income to populate an amount for spending money (FIGS. 6 and 19). The dashboard shown in FIGS. 6 and 19 will display the results used to formulate the method of balancing by the character 111 of method and/or software application 10. The method and/or software application 10 uses the current income and the next three pay periods from the dashboard to apply a mathematical method of balancing bills and spending money. The Left to Clear column will not be used in method and/or software application 10. Once the bills are split, the monies withheld will be marked pending and continue into the next and future pay periods “Left to Clear” (FIG. 7). All pending split payments continued into the next pay period will not affect the income or bill amounts, this may be an information only field. However, future calculations of the method and/or software application 10 income and Bills may include the amounts in the “Left to Clear” field.

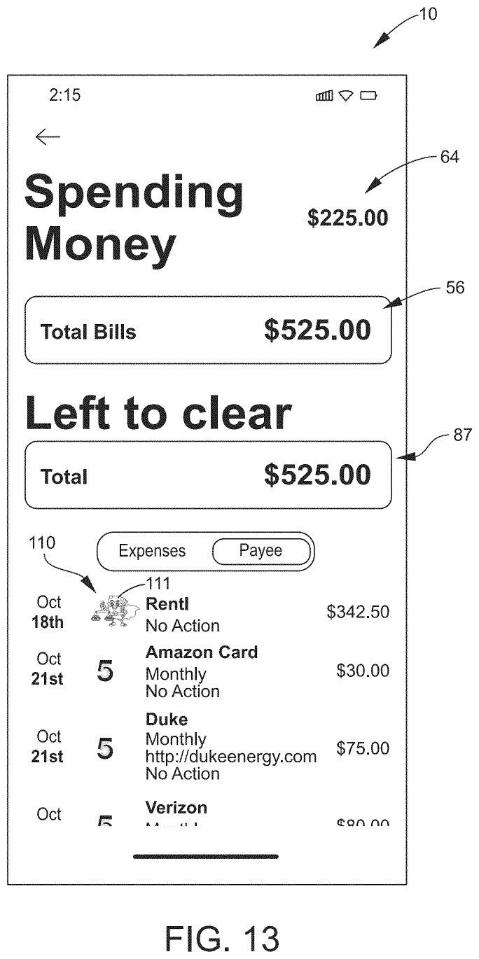

Once the character 111 of method and/or software application 10 is applied to the current and future pay periods, an icon or character 111 representing the bill balancer will be displayed on the same line as the split payment. (See FIGS. 13-15).

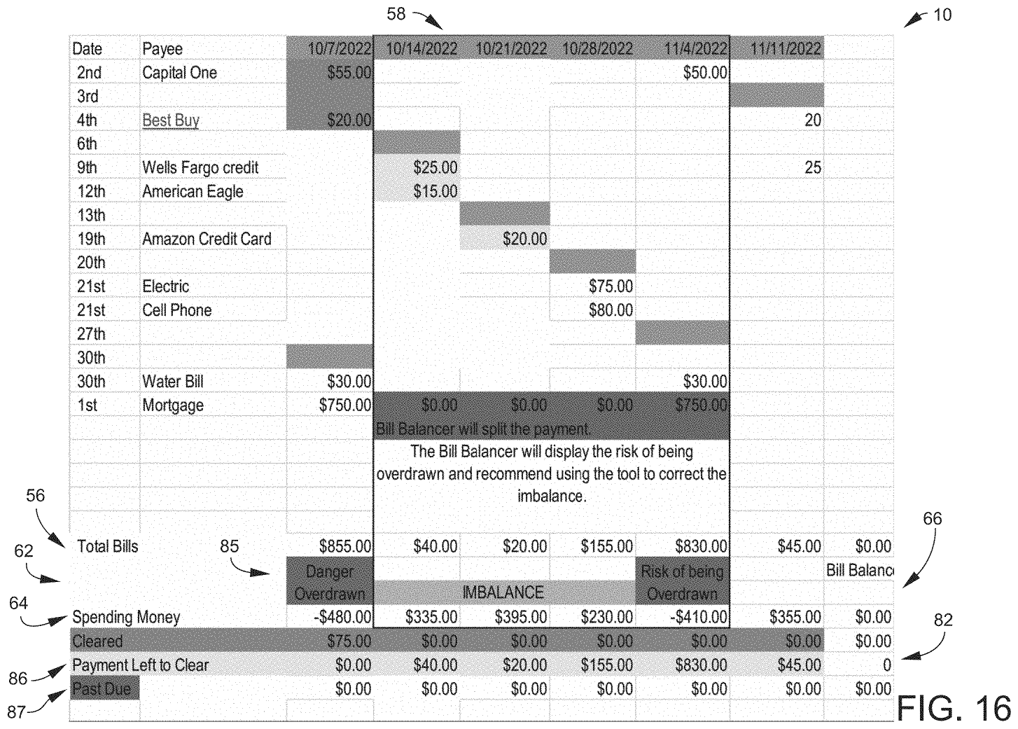

Referring now specifically to FIG. 16, the character 111 of method and/or software application 10 will display the risk of being overdrawn and recommend using the tool to correct the imbalance. The character 111 of method and/or software application 10 is recommended based on four weeks of forecasting with weekly paychecks.

$360+$380+$245−$430=$555

$555/4=$138.75

$138.75 is the amount of spending money each of the four weeks should have to balance the spending money.

Still referring to FIG. 16, as an Example Weekly Calculation:

$360.00−138.75=$221.25−$221.25 will be held for Oct. 28, 2022 mortgage payment

$380.00−138.75=$241.25 will be held

$245−$138.75=$106.25 will be held

$221.25+$241.25+$106.25−$750=$181.25

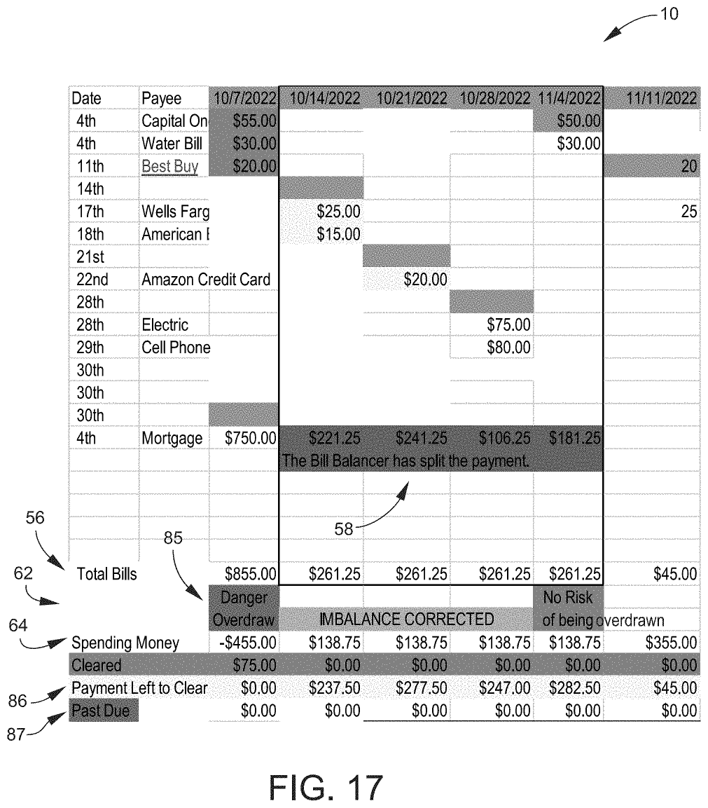

Referring now specifically to FIG. 17, note: Split payments can either be marked cleared if partial payment or pending if holding onto the money for the future. If pending the bill payment will continue to be shown on the current pay period as left to clear. The character 111 of method and/or software application 10 may recommend based on four weeks of forecasting with weekly paychecks. Notice the left to Clear has changed when the bills have been split.

In the specification and/or figures, typical embodiments of the disclosure have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein but is limited only by the following claims.

1. A method for managing personal finances comprising:
collecting information of at least one payee;
collecting information of at least one income;
determining a primary income by comparing the income amount of each income and determining which of the compared income amounts is the highest;
setting primary income frequencies equal to the income frequencies of the determined primary income;
calculating a total amount of bills from the information of each of the payees for each of the set primary income frequencies, wherein for any payee with a pay frequency that is larger than the primary income frequencies, splitting the average amount of such payees equally into each of the primary income frequencies whereby the total amount of bills is equal for each of the primary income frequencies;
calculating a total amount of income for each of the set primary income frequencies from the information of each of the incomes;
determining a spending money amount for each of the set primary income frequencies, where the spending money is equal to a difference of the calculated total amount of bills for the set primary income frequencies and the calculated total amount of income for the set primary income frequencies; and
using a mathematical algorithm configured to balance the determined spending money over a set period of time by averaging the determined spending money over said set period of time and setting a balanced spending money to the averaged spending money over said set period of time.

2. The method for managing personal finances of claim 1, wherein the mathematical algorithm configured to balance the spending money over a set period of time including:
if the total amount of bills for a pay period is less than a following pay period or if the spending money for the pay periods varies, creating an imbalance;
balancing the determined spending money including subtracting the imbalance from the previous amount of spending money, and then dividing the number of pay periods needed to correct the imbalance; and
wherein, the method for managing personal finances is configured to balance future bills and spending money.

3. The method for managing personal finances of claim 2, wherein, after balancing, the spending money is equal for the pay period and any following pay period, wherein the balancing includes splitting the imbalance by the number of weeks up to a due date.

4. The method for managing personal finances of claim 1, wherein the set period of time is between two to six weeks.

5. The method for managing personal finances of claim 1, wherein the collecting information of at least one payee including:
collecting the name of each payee;
collecting autodraft info of each payee;
collecting an average amount for each payee;
collecting a pay frequency for each payee; and
collecting a start date for each payee.

6. The method for managing personal finances of claim 5, wherein the information collected for each of the at least one payee is displayed under a perspective pay period.

7. The method for managing personal finances of claim 1, wherein the collecting information of at least one income including:
collecting an income frequency of each income; and
collecting an income amount of each income.

8. The method for managing personal finances of claim 7, wherein the income frequency being selected from a group consisting of: weekly; bi-weekly; monthly; bi-monthly; quarterly; and one time income.

9. The method for managing personal finances of claim 1 further including:
determining a risk of being overdrawn; and
breaking the payee into cleared amounts, payment left to clear amounts, and past due amounts.

10. The method for managing personal finances of claim 1, wherein:
the method includes a detailed process, and mathematical equations using the mathematical algorithm, wherein the method for managing personal finances is configured to work with user inputs, other authorized inputs and artificial intelligence to balance the amounts between a two-to-six-week period by forecasting bills and spending money from paycheck to paycheck;
the method is configured to use the mathematical algorithm and the artificial intelligence to balance a budget of a user thereby allowing the user to manage money;
the method is configured to give a detailed evaluation of one pay period bill total then evaluate the amount over the next two-to-six-week period, wherein the method will show an increase or decrease that will be recommended using the mathematical algorithm to balance bills and spending money;
the method is configured to utilize the mathematical algorithm with real-time information along with user input to calculate current monies spent on bills and spending money; or
combinations thereof.

11. A method for managing personal finances comprising:
collecting information of at least one payee, the information of each payee collected including the name of each payee, autodraft info of each payee, an average amount for each payee, a pay frequency for each payee, and a start date for each payee, wherein the information collected for each of the at least one payee is displayed under a perspective pay period;
collecting information of at least one income, the information of each income collected including income frequencies, and an income amount, wherein the income frequencies being selected from a group consisting of: weekly; bi-weekly; monthly; bi-monthly; quarterly; and one time income;
determining a primary income by comparing the income amount of each income and determining which of the compared income amounts is the highest;
setting primary income frequencies equal to the income frequencies of the determined primary income;
calculating a total amount of bills from the information of each of the payees for each of the set primary income frequencies, wherein for any payee with a pay frequency that is larger than the primary income frequencies, splitting the average amount of such payees equally into each of the primary income frequencies whereby the total amount of bills is equal for each of the primary income frequencies;
calculating a total amount of income for each of the set primary income frequencies from the information of each of the incomes;
determining a spending money amount for each of the set primary income frequencies, where the spending money is equal to a difference of the calculated total amount of bills for the set primary income frequencies and the calculated total amount of income for the set primary income frequencies;
using a mathematical algorithm configured to balance the determined spending money over a set period of time between two to six weeks by averaging the determined spending money over said set period of time and setting a balanced spending money to the averaged spending money over said set period of time, wherein the mathematical algorithm configured to balance the spending money over a set period of time including:
if the total amount of bills for a pay period is less than a following pay period or if the spending money for the pay periods varies, creating an imbalance;
balancing the determined spending money including subtracting the imbalance from the previous amount of spending money, and then dividing the number of pay periods needed to correct the imbalance;
wherein, the method for managing personal finances is configured to balance future bills and spending money;
determining a risk of being overdrawn;
breaking the payee into cleared amounts, payment left to clear amounts, and past due amounts;
wherein, after balancing, the spending money is equal for the pay period and any following pay period, wherein the balancing includes splitting the imbalance by the number of weeks up to a due date;
wherein, the method includes a detailed process, and mathematical equations using the mathematical algorithm, wherein the method for managing personal finances is configured to work with user inputs, other authorized inputs and artificial intelligence to balance the amounts between a two-to-six-week period by forecasting bills and spending money from paycheck to paycheck;
wherein, the method is configured to use the mathematical algorithm and the artificial intelligence to balance a budget of a user thereby allowing the user to manage money;
wherein, the method is configured to give a detailed evaluation of one pay period bill total then evaluate the amount over the next two-to-six-week period, wherein the method will show an increase or decrease that will be recommended using the mathematical algorithm to balance bills and spending money; and
wherein, the method is configured to utilize the mathematical algorithm with real-time information along with user input to calculate current monies spent on bills and spending money.

12. A software application for managing personal finances including:
collecting information of at least one payee;
collecting information of at least one income;
determining a primary income by comparing the income amount of each income and determining which of the compared income amounts is the highest;
setting primary income frequencies equal to the income frequencies of the determined primary income;
calculating a total amount of bills from the information of each of the payees for each of the set primary income frequencies, wherein for any payee with a pay frequency that is larger than the primary income frequencies, splitting the average amount of such payees equally into each of the primary income frequencies whereby the total amount of bills is equal for each of the primary income frequencies;
calculating a total amount of income for each of the set primary income frequencies from the information of each of the incomes;
determining a spending money amount for each of the set primary income frequencies, where the spending money is equal to a difference of the calculated total amount of bills for the set primary income frequencies and the calculated total amount of income for the set primary income frequencies; and
using a mathematical algorithm configured to balance the determined spending money over a set period of time by averaging the determined spending money over said set period of time and setting a balanced spending money to the averaged spending money over said set period of time.

13. The software application for managing personal finances of claim 12, wherein the mathematical algorithm configured to balance the spending money over a set period of time including:
if the total amount of bills for a pay period is less than a following pay period or if the spending money for the pay periods varies, creating an imbalance;
balancing the determined spending money including subtracting the imbalance from the previous amount of spending money, and then dividing the number of pay periods needed to correct the imbalance; and
wherein, the software application for managing personal finances is configured to balance future bills and spending money;
wherein, after balancing, the spending money is equal for the pay period and any following pay period, wherein the balancing includes splitting the imbalance by the number of weeks up to a due date; and
displaying a character around any information that was balanced.

14. The software application for managing personal finances of claim 12, wherein the set period of time is between two to six weeks.

15. The software application for managing personal finances of claim 12, wherein the collecting information of at least one payee including:
collecting the name of each payee;
collecting autodraft info of each payee;
collecting an average amount for each payee;
collecting a pay frequency for each payee; and
collecting a start date for each payee.

16. The software application for managing personal finances of claim 15, wherein the information collected for each of the at least one payee is displayed under a perspective pay period.

17. The software application for managing personal finances of claim 12, wherein the collecting information of at least one income including:
collecting an income frequency of each income; and
collecting an income amount of each income.

18. The software application for managing personal finances of claim 17, wherein the income frequency being selected from a group consisting of: weekly; bi-weekly; monthly; bi-monthly; quarterly; and one time income.

19. The software application for managing personal finances of claim 12 further including:
determining a risk of being overdrawn and displaying said risk; and
breaking the payee into cleared amounts, payment left to clear amounts, and past due amounts, and displaying the cleared amounts, payment left to clear amounts, and past due amounts.

20. The software application for managing personal finances of claim 12, wherein:
the software application includes a detailed process, and mathematical equations using the mathematical algorithm, wherein the software application for managing personal finances is configured to work with user inputs, other authorized inputs and artificial intelligence to balance the amounts between a two-to-six-week period by forecasting bills and spending money from paycheck to paycheck;
the software application is configured to use the mathematical algorithm and the artificial intelligence to balance a budget of a user thereby allowing the user to manage money;
the software application is configured to give a detailed evaluation of one pay period bill total then evaluate the amount over the next two-to-six-week period, wherein the software application will show an increase or decrease that will be recommended using the mathematical algorithm to balance bills and spending money;
the software application is configured to utilize the mathematical algorithm with real-time information along with user input to calculate current monies spent on bills and spending money;
the software application is an internet application; or
combinations thereof.
